(19) United States
(12) Patent Application Publication
(10) Pub. No.: US 2024/0354439 A1
(43) Pub. Date: Oct. 24, 2024

(54) SYSTEMS AND METHODS FOR SECURING SENSITIVE DATA

(71) Applicant: Nathaniel J. Britell, Wellington, FL (US)

(72) Inventor: Nathaniel J. Britell, Wellington, FL (US)

(21) Appl. No.: 18/305,542

(22) Filed: Apr. 24, 2023

(51) Int. Cl. G06F 21/62

(52) U.S. Cl. CPC G06F 21/6245

(57) ABSTRACT

Systems and methods for securing sensitive data include capturing input data in a surrounding environment of an electronic device through one or more data capture units of the electronic device; executing a comparative analysis of the captured input data by a data recognition program stored in a memory of the electronic device to search for security tags within the captured input data; and, upon detecting a security tag within the captured input data, identifying and executing a security measure associated with the detected security tag. The electronic device is operable in a persistent state in which input data is continuously captured, and comparative analyses of the captured input data are repeatedly executed, with execution of security measures upon the detection of any security tags, until such time that the persistent state is deactivated.

### FIELD OF THE INVENTION

The present invention relates to systems and methods for the protection of sensitive data. In particular, the present invention is directed to security programs for identifying sensitive data and executing security measures to protect sensitive data, and system for performing the same.

### BACKGROUND OF THE INVENTION

Sensitive data is any information that is considered to have a perceived value, either monetary or otherwise, and which is to be retained in secrecy with only limited authorized access. Examples of sensitive data include, though are not limited to: personal identifying information (PII) (e.g., social security numbers; medical history); business information (e.g., trade secrets; business strategies and know-how); and government information (e.g., information classified as restricted, confidential and top-secret information).

Sensitive data must be secured against unauthorized access to avoid loss of the perceived value. While there have been several technological advancements in the protection of sensitive data, human intervention remains arguably weakest link. Human intervention can result in a failure to securing sensitive data as a result of bringing an unsecured electronic device into a secure area; taking photographs or otherwise copying sensitive data; and leaving materials containing sensitive data in an unsecure location or state. Attempts have been made to reduce security failures due to human intervention by, for example, using safety briefs; electronic device detectors at the entry to secure sites; and employing security personnel trained in standard-operating-procedures (SOPs) for securing sensitive data.

While conventional methods provide a degree of protection, there remains a need for further improvements to securing sensitive data, including further protection from leaks due to human intervention generally.

### SUMMARY OF THE INVENTION

An electronic device for securing sensitive data comprises one or more data capture units, a processor, memory accessible by the processor, and program instructions and data stored in the memory and executable by the processor. The one or more data capture units are configured for capturing input data from a surrounding environment of the electronic device. The processor is configured to control a security program stored in the memory to activate a persistent state of the electronic device in which the one or more data capture units continuously capture input data from the surrounding environment of the electronic device; control a data recognition program stored in the memory to execute a comparative analysis of input data captured by the one or more data capture units to search for security tags within the captured input data; and, upon detecting a security tag within the captured input data, identify and execute one or more security measures associated with the detected security tag.

The electronic device is configured to temporarily store input data captured by the one or more data capture units in a temporary memory for use by the security program. When operating in the persistent state, the electronic device continuously captures input data from the surrounding environment and repeatedly executes comparative analyses of input data captured by the one or more data capture units to search for security tags within the captured input data, and execute one or more security measures upon detecting a security tag, until such time that the processor controls the security program to deactivate the persistent state. The electronic device is configured to delete captured input data from the temporary memory after executing a comparative analysis to search the captured data for security tags.

The one or more data capture units are configured to capture input data in the form of at least one of image data and audio data, and the processor is configured to control the security program to execute the comparative analysis in the form of at least one of an image matching analysis and an audio matching analysis. The security program executes comparative analyses by comparing captured input data to pre-loaded recognition data stored in the memory. The pre-loaded recognition data comprises a security index comprising security tag identifiers for security tags that are predetermined to be in the environment of the electronic device and one or more security measures associated with each security tag identifier.

The security program is configured to execute the comparative analysis of the captured input data to search for security tags in the form of at least one of an optical security tag and an auditory security tag. The security program is configured to execute security measures that comprise deactivating one or more capture units of the electronic device, and controlling the electronic device to communicate with one or more external devices for triggering the external device to execute a security action in the environment of the electronic device. Security actions that may be triggered by an external device include: depowering one or more external devices in the environment of the electronic device; closing and/or locking one or more entry and/or exit ways in the environment of the electronic device; and alerting security services in the environment of the electronic device.

Both the foregoing general description and the following detailed description are exemplary and explanatory only and are intended to provide further explanation of the invention as claimed. The accompanying drawings are included to provide a further understanding of the invention; are incorporated in and constitute part of this specification; illustrate embodiments of the invention; and, together with the description, serve to explain the principles of the invention.

### BRIEF DESCRIPTION OF THE DRAWINGS

Further features and advantages of the invention can be ascertained from the following detailed description that is provided in connection with the drawings described below:

FIG. 1 shows a general process for securing sensitive data with an electronic device;

FIG. 2 shows a security program on an electronic device running in a persistent state, according to the general process in FIG. 1;

FIG. 3 shows a printed document with a number of security tags provided thereon;

FIG. 4 shows a security index for use in the security program of FIG. 2;

FIG. 5 shows an electronic device for executing a security program according to the present invention; and

FIG. 6 shows a computing device for executing a security program according to the present invention.

### DETAILED DESCRIPTION OF THE INVENTION

The following disclosure discusses the present invention with reference to the examples shown in the accompanying drawings, though does not limit the invention to those examples.

The use of any and all examples, or exemplary language (e.g., “such as”) provided herein is intended merely to better illuminate the invention and does not pose a limitation on the scope of the invention unless otherwise claimed. No language in the specification should be construed as indicating any non-claimed element as essential or otherwise critical to the practice of the invention, unless otherwise made clear in context.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context.

Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted.

Human intervention presents a significant concern in preserving sensitive data. The present invention seeks to improve the security of sensitive data by providing safeguards against human intervention. The methods and systems provided by the present invention may be employed for further securing sensitive data of several different forms, including though not limited to visually-conveyed data and audibly-conveyed data. The foregoing examples are not exhaustive of all data types, and sensitive data may be present in a form that includes a combination of multiple data types. For example, sensitive data stored in an electronic format (e.g., computer accessible files) may include visually conveyed information (e.g., electronic documents viewable on a display screen) and/or an audibly conveyed information (e.g., sound recordings playable through a speaker).

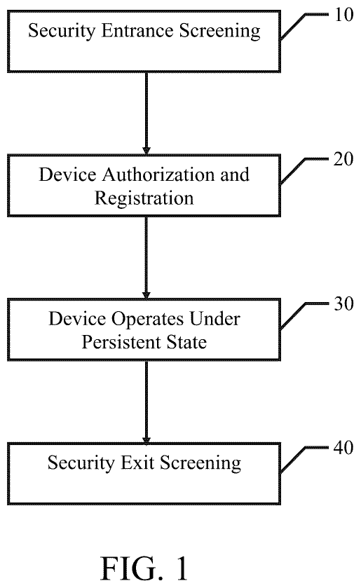

FIG. 1 shows a general process for securing sensitive data through use of a security program installed on an individual's electronic device (e.g., a cell phone; an image and/or video camera; a voice recorder; etc.).

Before entering a secure site where sensitive data is known to be stored, an individual will first undergo a security entrance screening (Step 10) which includes a device screening to search for any electronic devices in the possession of the individual. Device screening may be performed by human personnel who interact with the individual and/or an automated system with which the individual must interact to gain access to the secure site. Device screening may include the use of electronic device detection systems (e.g., x-ray machines, cell phone detectors, etc.), and when human personnel are present may include a physical search of the individual's person (e.g., a body search).

All electronic devices on in the person's possession must either be deposited for storage while the individual enters the secure site, or otherwise authorized and registered for entry into the secure site (Step 20). Registration of an electronic device for entry into the secure site includes analyzing the electronic device to determine if a requisite security program is installed on the electronic device. If it is determined that the security program is already installed on the electronic device, then the security program is engaged to activate a persistent operational state. If it is determined that the security program is not present on the electronic device, then the security program is installed on the electronic device and engaged to activate a persistent operational state. If an electronic device does not contain the requisite security program, and is incompatible for installation of the security program, then the electronic device must be deposited for storage while the individual enters the secure site.

Registration of the electronic device for entry into the secure site (Step 20) further includes analyzing the electronic device to confirm that it has all requisite pre-loaded security data that the security program requires for the corresponding secure site. The requisite pre-loaded security data includes necessary information for identifying all security tags that are present at the corresponding secure site (e.g., image data for optical security tags and audio data for auditory security tags) and a security index identifying all security measures associated with each security tag. The pre-loaded security data further includes any programs, software or other communications standards that are needed for the electronic device to execute all possible security measures at the corresponding secure site (e.g., communication frequencies for communicating with local security devices and/or security personnel).

Registration of the electronic device may be performed by human personnel and/or an automated system with which the individual must interact to gain access to the secure site. When analyzing the electronic device for presence of the security program, a search may be made of the electronic device's memory to verify presence of the security program and the requisite pre-loaded security data. The security program may include information identifying the electronic device as well as the authorized user/owner of that electronic device, which may include the name, position and any security clearance of the user/owner of the device. The security program may further include a one-sided encryption key. Optionally, presence of the security program on the electronic device may be checked by a local device at the secure site that transmits a first signal to the electronic device and awaits receipt of a second transmitted signal from the electronic device (e.g., a radio frequency identification (RFID) signal) to confirm presence of the requisite security program, the pre-loaded security data, and the identifying information of the device and/or authorized user.

While the individual is at the secure site, the security program will continue to operate in the persistent state (Step 30), which is discussed in further detail herein. Upon exiting the secure site, the individual will undergo a security exit screening (Step 40) during which all deposited electronic devices will be returned to the user, and the security program on any electronic devices that were registered for entry into the secure site will be disengaged to thereby discontinue the persistent state.

A secure site may be any site at which it is known that secure information is stored and/or intended for conveyance. At these secured sites, mediums that store and/or transmit sensitive data may be provided with one or more security tags, and all electronic devices authorized and registered for entry into the secure site will be programmed in advance with a security program that searches for and detects the security tags. Upon detecting a security tag, the security program triggers the electronic device to execute one or more security measures to prevent unauthorized reproduction or conveyance of sensitive data.

Mediums that store and/or convey sensitive data may be provided with one or more security tags that corresponds with the nature of the sensitive data and/or the medium(s) in which the sensitive data is stored. Examples of mediums that may store and/or transmit sensitive data, along with a corresponding security tag, are physical mediums (e.g., printed documents), digital mediums (e.g., electronic text and audio files), and ambient mediums (e.g., signals from surrounding environment). Examples of security tags include optical security tags adapted for optical recognition by an electronic device, and auditory security tags adapted for auditory recognition by an electronic device. The types of security tags used in any particular instance may depend on the specific medium in use, as well as the nature of the sensitive data stored within the medium.

In mediums that store sensitive data for optical transmission, such as printed documents or electronic files viewable though a display screen, the medium may include one or more optical security tags, such as though not limited to: visual labels, and machine readable code. Visual labels may include, for example, watermarks, logos, and other uniquely identifiable images. Machine readable code may include, for example, character code sequences and/or image code sequences. Character code sequences may be provided, for example, in the form of alphabetical sequences, numerical sequences, or alphanumeric sequences. Image code sequences may be provided, for example, in the form of two or three dimensional image sequences, including though not limited to: a series of shapes (lines, dots, triangles, squares, etc.), line barcodes and matrix barcodes (e.g., quick response (QR) codes).

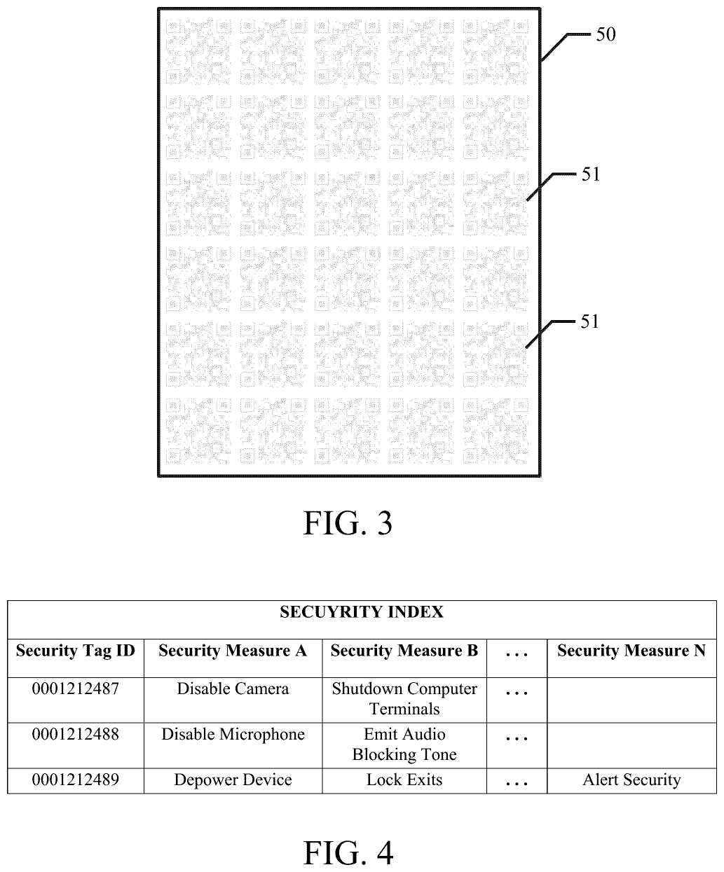

FIG. 3 shows one example of a printed document 50 on which a number of security tags 51 are present in the form of three-dimensional image sequences, specifically matrix barcodes (QR codes), which are provided on the document as watermarks. Though not shown in FIG. 3, the document 50 would further include text and/or images that would be treated as sensitive data, and the security tags 51 would be associated with that sensitive data for securing protection thereof. In other examples, the printed document 50 may have more or fewer security tags 51, which may be provided in any other suitable form, number and/or size. It is preferable that the document be provided with several security tags (e.g., hundreds or even thousands) in a pattern over the surface of the document as this is expected to provide a greater assurance that at least one security tag will be detected, thereby triggering security measures for protecting the sensitive data in the document from unauthorized conveyance and/or reproduction. In this regard, it is preferable that the security tags be provided in the smallest size possible while remaining detectable by the electronic device. In some examples an optical security tag may be provided in the form of a repeating texture that is either a physical or purely optical element of the printed document.

Digital mediums that store sensitive data for optical transmission may include an optical security tag in the form of an optical transmission signal that is specially adapted for detection by electronic devices. For example, an electronic file containing sensitive data intended for viewing through a display screen may be programmed to cause the display screen to emit a visual signal with a predetermined pattern. This could be achieved, for example, by causing variations in a refresh rate of the display screen with a predetermined pattern, which may include variations imperceptible to the human eye though detectable by an electronic device.

In mediums that store sensitive data for audible transmission, such as electronic files with audio recordings that are playable though a speaker, the medium may include one or more auditory security tags in the form of an audible tone that is adapted for auditory recognition by an electronic device. Auditory security tags may also be referred to as sonic security tags, and may comprise frequencies detectable by the human ear or may be composed only of frequencies imperceptible to the human car though detectable by an electronic device.

In examples of mediums containing sensitive data for both optical and auditory transmission, such as an electronic file containing both images for conveyance through a display screen and an audio recording playable through a speaker, the medium may be provided with one or more optical security tags in combination with one or more auditory security tags.

A secure site may also to provide one or more security tags in one or more ambient mediums. That is, separate from any security tags provided within a medium that itself stores and/or transmits sensitive data, one or more security tags may be provided in an ambient medium that does not itself store or transmit sensitive data but which is present in the environment of the secure site. For example, in a secure site where sensitive data is stored or conveyed in an audio form, the secure site may be provided with one or more speakers that emit a sound recording that contains an auditory security tag comprising frequencies that are detectable by an electronic device separate from standard audio inputs. As another example, in a secure site where sensitive data is stored or conveyed in an optical form, the secure site may be provided with one or more light emitting devices that emit an optical security tag, such as light in a wavelength and/or pattern that is adapted for detection by an electronic device separate from standard light inputs (e.g., infra-red frequencies).

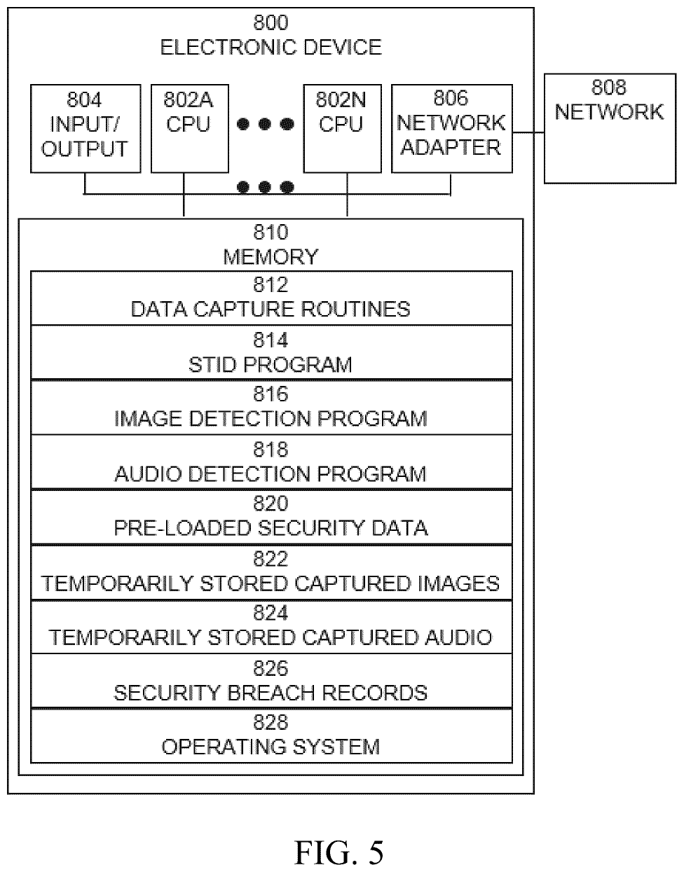

As seen in the example in FIG. 5, a user's electronic device 800 is programmed in advance with security tag identification (STID) program 814 that is stored in a local memory 810 of the device and executable by a local processor 802 (802A-802N) of the device 800. The STID program 814 is programmed to control the electronic device 800 to search for and detect security tags within a number of mediums, and to respond upon detection of a predetermined security tag to trigger one or more security measures corresponding with the detected security tag.

The STID program 814 may include a number sub-programs depending on the type of security tags with which the electronic device is configured to interact. In some examples, the STID program 814 may include image detection programs 816 for detecting and identifying optical security tags through use of a camera or other image capture unit 804 on the electronic device 800, and in some examples the STID program may include audio detection programs 818 for detecting and identifying auditory security tags through use of a microphone or other audio capture unit 804 on the electronic device 800. These detection programs will be developed in advance of installation on the electronic device through program modeling and training, in which the programs are trained to recognize predetermined images (e.g., still images and/or video images) and/or audio waveforms so that it may later accurately detect and identify the same. The STID program 814 may include both image and audio detection programs 814/816, as well additional programs for detecting one or more further types of security tags in any other chosen mediums.

Preferably, the STID program 814 is programmed to execute a persistent operational state in which the electronic device 800 is controlled to constantly capture input data and search for security tags in any medium that is detectable by input devices 804 of the electronic device 800. In this way, when the STID program 814 is switched to the persistent state, the input units 804 corresponding with the loaded detection programs (e.g., image detection program 816; audio detection program 818) will constantly execute corresponding data capture routines 812 to capture data inputs that are then searched by the corresponding detection programs 816/818 for any identifiable security tags. Thus, when the STID program 814 includes an image detection program 816, a camera or other image capture unit 804 will constantly receive and capture image input and search for any predetermined optical security tags within said captured image input; and when the STID program 814 includes an audio detection program 818, a microphone or other audio capture unit 804 will constantly receive and capture audio input and search for any predetermined auditory security tags within said captured audio input. In some examples, the persistent state may be active at all times that the electronic device 800 is in a powered-on state, and in some examples the persistent state may be selectively activated and deactivated. An always on persistent state may be preferable if the electronic device 800 is one intended for use only at a secure site (e.g., an onsite security device), whereas a selectively activated persistent state may be preferable if the electronic device 800 is one intended for uses separate from the secure site (e.g., a user's personal device). When using a selectively activated persistent state, the persistent state may be activated during a device authorization and registration process (Step 20), following a security entrance screening (Step 10), when the individual first enters a secure site, with the electronic device remaining in the persistent operational state (Step 30) until deactivated during a security exit screening (Step 40) when the individual exits the secure site.

Additional pre-loaded security data 820 is also stored in the local memory 810 for use by the STID program 814. The pre-loaded security data may include security tag information for identifying all security tags that present at a corresponding secure site—for example, image recognition data (e.g., pre-loaded images) for identifying optical security tags and/or audio recognition data (e.g., pre-loaded audio files) for identifying auditory security tags. The pre-loaded security data also includes a security index identifying all security measures associated with each security tag. The security index may be provided, for example, in a tabulated form in which a security tag identifier is provided in a first data field and one or more security measures that are associated with the security tag identifier are provided in one or more corresponding data fields. One example of a portion of a security index is provided in FIG. 4. The pre-loaded security data further includes any programs, software or other communications standards that are needed for the electronic device to execute all possible security measures at the corresponding secure site (e.g., communication standards and/or frequencies for communicating with security devices and/or security personnel at the secure site or elsewhere).

The STID program 814 may execute a comparative analysis to search for any matches between captured inputs and the pre-loaded security tag information. For example, captured inputs (e.g., captured image and/or audio inputs) may be temporarily stored in the memory 810, and the STID program 814 may execute a comparative analysis between temporarily stored captured images 822 and pre-loaded image recognition data to identify any optical security tags in the temporarily stored captured images 822 and/or may execute a comparative analysis between temporarily stored captured audio 824 and pre-loaded audio recognition data to identify any auditory security tags in the temporarily stored captured audio 824.

If the STID program 814 identifies a match between a captured input and pre-loaded security tag information, then the STID program 814 executes a corresponding security measure that is associated with the identified security tag in the security index. A security measure may be any action that promotes prevention of unauthorized communication or reproduction of sensitive data, and a single security tag may be associated with any number of varying security measures.

In some examples, an optical security tag identifying the presence of sensitive data subject to optical conveyance may be associated with one or more security measures that disable the electronic device 800 from capturing optical input, such as disabling a camera or other image capturing unit 804. In other examples, an auditory security tag identifying the presence of sensitive data subject to audible conveyance may be associated with one or more security measures that disable the electronic device 800 from capturing auditory input, such as disabling a microphone or other audio capture unit 804. In some examples the security measure may include disabling or depowering the electronic device 800 in its entirety.

A security measure may also cause the electronic device 800 to communicate with other devices external to the electronic device 800 itself, such as causing the electronic device 800 to transmit a signal, such as through a network adapter 806 and across a network 808, to one or more security devices in the environment of the secure site such that those external security devices are triggered to secure the sensitive data. For example, a security tag identifying sensitive data subject to optically conveyance may be associated with a security measure that commands the electronic device 800 to communicate with an external device that controls one or more light emitting devices in the environment of the secure site, with those external devices being triggered to turn off all light-emitting devices or otherwise emit light at a frequency that interrupts or causes interference in data collection by the image capture units 804 of the electronic device 800. In another example, a security tag identifying sensitive data subject to audible conveyance may be associated with a security measure that commands the electronic device 800 to communicate with an external device that controls one or more sound emitting devices in the environment of the secure site, with those external devices being triggered to turn off all sound-emitting devices or otherwise emit a sound at a frequency that interrupts or causes interference in data collection by the audio capture units 804 of the electronic device 800.

Other external security measures may include causing the electronic device 800 to communicate with external devices that turn off all electronic devices in the secure site (e.g., shutting down all computer terminals); lock all entry/exit ways (e.g., closing and locking all doors and windows); and/or transmit an alert message to security personnel (e.g., triggering an alarm, or transmitting signals to the personal communications devices of security personnel).

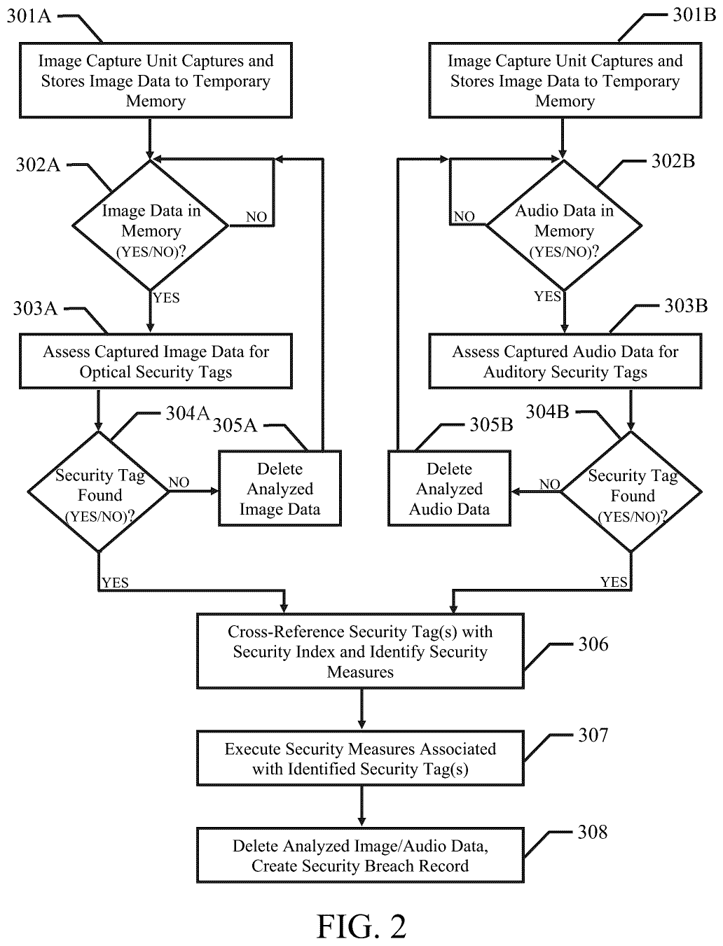

FIG. 2 shows a one example of a security program running in a persistent state (Step 30) according to the general process in FIG. 1. In this example, an individual's electronic device 800 has been provided with a security program either prior to or during a device authorization and registration process (Step 10) at a secure site. In this example, the security program is provided with a STID program that includes both an image detection program and an audio detection program that run in parallel to one another. In other examples, the security program may be provided with a STID program that has only a single one of the image detection program or the audio detection program, and the STID program will omit corresponding steps and process for the omitted detection program.

In this example, following activation of the persistent state, an optical security tag detection process is executed in which one or more image capture units 804 of the electronic device 800 operate to persistently capture image data, and temporarily store the captured image data to a local temporary memory 822 of the electronic device 800 (Step 301A). A processor 802 of the electronic device 800 repeatedly checks the temporary memory 822 for captured image data (Step 302A), and when there is detected captured image data in the temporary memory 822 (Step 302A: “YES”) the processor 802 executes the image detection program 816 to analyze the captured image data for the presence of any optical security tags by comparing the captured image data stored in the temporary memory 822 to pre-loaded image data from the pre-loaded security data 820 (Step 303A). If the image detection program 816 does not identify any security tags within the captured image data (Step 304A: “NO”), then the captured image data that was determined to not contain any security tags is deleted from the temporary memory 822 (Step 305A) and the process repeats by continuing to check the temporary memory 822 for any captured image data and assessing any image data stored therein for the presence of any optical security tags (Steps 302A-304A).

In this example, in parallel with the optical security tag detection process, an auditory security tag detection process is executed in which one or more audio capture units 804 of the electronic device 800 operate to persistently capture audio data, and temporarily store the captured audio data to a local temporary memory 824 of the electronic device 800 (Step 301b). The processor 802 of the electronic device 800 repeatedly checks the temporary memory 824 for captured audio data (Step 302B), and when there is detected captured audio data in the temporary memory 824 (Step 302B: “YES”) the processor 802 executes the audio detection program 818 to analyze the captured audio data for the presence of any auditory security tags by comparing the captured audio data stored in the temporary memory 824 to pre-loaded audio data from the pre-loaded security data 820 (Step 303B). If the audio detection program 318 does not identify any security tags within the captured audio data (Step 304B: “NO”), then the captured audio data that was determined to not contain any security tags is deleted from the temporary memory 824 (Step 305B) and the process repeats by continuing to check the temporary memory 824 for any captured audio data and assessing any audio data stored therein for the presence of any auditory security tags (Steps 302B-304B).

If either the image detection program 816 or the audio detection program 818 identifies one or more security tags in any captured data (Step 304A: “YES”; or Step 304B: “YES”), then the processor 802 cross-references each identified security tag with the security index from the pre-loaded security data 820 to identify all security measures associated with each identified security tag (Step 306), and the processor 802 then commands the electronic device 800 to execute each security measure associated with each identified security tag (Step 307). The analyzed captured data (image and/or audio) is deleted from the temporary memory 822/824 (Step ##). Optionally, a security breach record 826 may be created in the memory 810 of the electronic device 800 identifying the detected security tag(s) and associated security measure(s) so that such information may later be reviewed to assess any security breach committed by the individual in possession of the electronic device 800. Preferably, a security breach record 826 does not include captured data (image or audio), thereby avoiding retention of any sensitive data, and instead contains only information on the identified security tag(s) and/or security measure(s) which may be cross-referenced by a reviewing entity with use of an external database separate from the electronic device 800 to identify the sensitive data associated with the recorded security tag(s) and/or security measure(s).

FIG. 5 shows one example of an electronic device 800 according to the present invention, in which processes described herein may be implemented. The electronic device 800 may be a programmed general-purpose computing system, such as an embedded processor, system on a chip, personal computing system, cell phone, image and/or video camera, audio recorder, etc. The electronic device 800 may include one or more processors (CPUs) 802A-802N, data capture devices 804 in the form of one or more input/output circuitry, a network adapter 806 for communicating with a network 808, and a memory 810.

CPUs 802A-802N execute program instructions to carry out the functions of the present invention. Typically, CPUs 802A-802N are one or more microprocessors, microcontrollers, processor in a system-on-chip, etc. FIG. 5 illustrates an example in which the electronic device 800 is implemented as a single multi-processor computing system, in which multiple processors 802A-802N share system resources, such as memory 810, input/output circuitry 804, and network adapter 808. However, the present invention also contemplates examples in which the electronic device 800 is implemented as a plurality of individualized computing systems, which may each be single-processor computing systems, multi-processor computing systems, or a mix thereof.

Data capture units, in the form of input/output circuitry 804, provide data capture capability to input data to, or output data from, the electronic device 800. For example, input/output circuitry 804 may include input devices, such as cameras, microphones, sensors, keyboards, mice, touchpads, trackballs, scanners, etc., output devices, such as monitors, video adapters, speakers, printers, etc., and input/output devices, such as, modems, etc. Network adapter 808 provides an interface for the electronic device 808 with a network 810. Network 810 may be any public or proprietary LAN or WAN, including, but not limited to the Internet, as well as closed-circuit systems, such as a closed circuit communications system for local security devices at a secure site.

Memory 810 stores program instructions that are executed by, and data that are used and processed by, the CPUs 802A-802N to perform the functions of the electronic device 800. Memory 810 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 810 may vary depending upon the function that electronic device 800 is programmed to perform. One of skill in the art will recognize that operational routines, along with the memory contents related to those routines, may not typically be included on one system or device, and may be distributed among a plurality of systems or devices, based on well-known engineering considerations. The present invention contemplates any and all such arrangements.

In the example shown in FIG. 5, memory 810 includes data capture routines 812, STID program 814, image detection program 816, audio detection program 818, pre-loaded security data 820, temporary storage of captured image data 822, temporary storage of captured audio data 824, security breach records 826, and an operating system 828. For example, data capture routines 812 may include routines for controlling the data capture units 804 (image, audio, etc.) to capture input data and store the same in temporary memory 822/824. Image detection program 816 and audio detection program 818 may include subroutines for executing detection algorithms identifying and matching captured data in the temporary memory 822/824 with recognition data from the pre-loaded security data 820, and the STID program 814 may include routines for employing results from the detection programs 816/818 for identifying security tags, identifying security measures associated with identified security tags, executing identified security measures, and optionally creating security breach records 826. The operating system 828 provides routines for overall system functionality of the electronic device 800.

In another aspect of the present invention, computing devices 900 that display information containing sensitive data subject to optical conveyance may be programmed with a security program 914 that contains a device detection program 916 for identifying any electronic devices having image capture units that are capable of conveyance or reproduction of optically conveyed sensitive data—e.g., photographic cameras, video cameras, and any other devices with image capturing units (e.g., cell phones), and for executing security measures upon identifying any such electronic devices.

The device detection program 914 will be developed in advance of installation on the computing device 900 through program modeling and training, in which the program is trained to recognize predetermined devices having image capture units so that they may be accurately detected and identified. This training may also include training the computing device 900 to identify devices that are predetermined to not have image capture units so that those devices may be positively identified as not presenting a security risk.

As with an individual's electronic device 800, the computing device 900 may also be provided with pre-loaded security data 918 that the security program 914 requires for the corresponding secure site. The pre-loaded security data 918 includes a security index similar to that provided on a user's electronic device 800, though this security index will comprise a listing of electronic device identifiers (in place of security tag identifiers) for identifying prohibited electronic devices that present a security risk in a first field of the index and one or more security measures associated with each electronic device identifier in one or more further fields of the index. The pre-loaded security data 918 further includes any programs, software or other communications standards that are needed for the computing device 900 to execute all possible security measures at the corresponding secure site (e.g., communication frequencies for communicating with local security devices and/or security personnel).

In operation, the computing device 900 will operate in an always on persistent state in which one or more image capturing units 904 of the computing device 900 will operate to continuously receive image data input and analyze all captured image data to search for any identifiable electronic devices that are predetermined to have one or more image capture units (e.g., a prohibited device). Upon detecting a prohibited device, the computing device 900 will cross-reference the detected device with the security index stored in the local memory 910, and will execute all security measures associated with the detected computing device. Optionally, the computing device 900 may create a security breach record 922 in the memory 910 identifying any detected prohibited electronic device and associated security measure so that such information may later be reviewed to assess any security breach committed at the computing device 900. The security breach record 922 may further comprise user history information, identifying at least a user of the computing device 900 at the time when a prohibited electronic device was detected and/or when the security measure was executed.

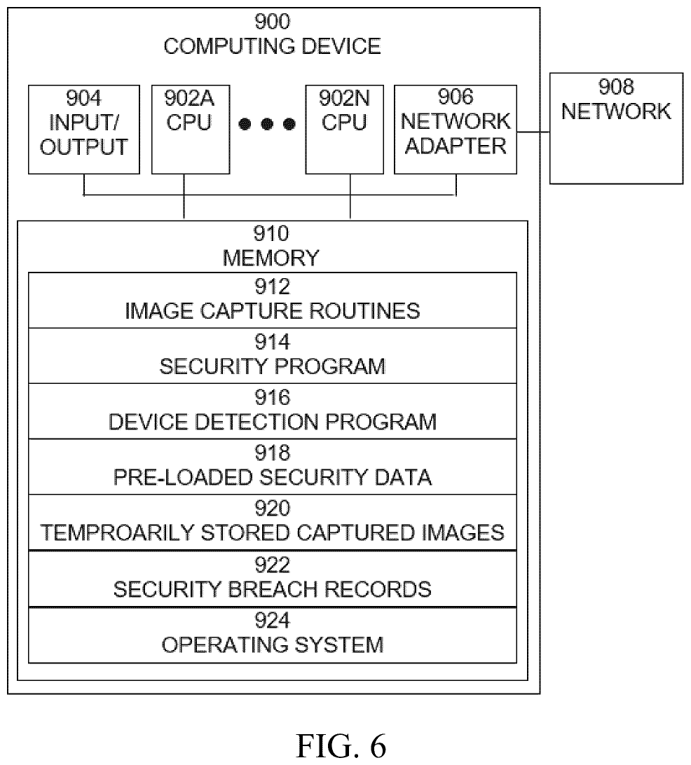

FIG. 6 shows one example of a computing device 900 according to the present invention, in which processes described herein may be implemented. The computing device 900 may be a programmed general-purpose computing system, such as an embedded processor, system on a chip, personal computing system, etc. The computing device 900 may include one or more processors (CPUs) 902A-902N, image capture units 904 in the form of one or more input/output circuitry, a network adapter 906 for communicating with a network 908, and a memory 910.

CPUs 902A-902N execute program instructions to carry out the functions of the present invention. Typically, CPUs 902A-902N are one or more microprocessors, microcontrollers, processor in a system-on-chip, etc. FIG. 6 illustrates an example in which the computing device 900 is implemented as a single multi-processor computing system, in which multiple processors 902A-902N share system resources, such as memory 910, input/output circuitry 904, and network adapter 908. However, the present invention also contemplates examples in which the computing device 900 is implemented as a plurality of individualized computing systems, which may each be single-processor computing systems, multi-processor computing systems, or a mix thereof.

Data capture units, in the form of input/output circuitry 904, provide data capture capability to input data to, or output data from, the computing device 900. For example, input/output circuitry 904 may include input devices, such as cameras, microphones, sensors, keyboards, mice, touchpads, trackballs, scanners, etc., output devices, such as monitors, video adapters, speakers, printers, etc., and input/output devices, such as, modems, etc. Network adapter 908 provides an interface for the electronic device 908 with a network 910. Network 910 may be any public or proprietary LAN or WAN, including, but not limited to the Internet, as well as closed-circuit systems, such as a closed circuit communications system for local security devices at a secure site.

Memory 910 stores program instructions that are executed by, and data that are used and processed by, the CPUs 902A-902N to perform the functions of the computing device 900. Memory 910 may include, for example, electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra-direct memory access (UDMA), or a small computer system interface (SCSI) based interface, or a variation or enhancement thereof, such as fast-SCSI, wide-SCSI, fast and wide-SCSI, etc., or Serial Advanced Technology Attachment (SATA), or a variation or enhancement thereof, or a fiber channel-arbitrated loop (FC-AL) interface.

The contents of memory 910 may vary depending upon the function that computing device 900 is programmed to perform. One of skill in the art will recognize that operational routines, along with the memory contents related to those routines, may not typically be included on one system or device, and may be distributed among a plurality of systems or devices, based on well-known engineering considerations. The present invention contemplates any and all such arrangements.

In the example shown in FIG. 6, memory 910 includes image capture routines 912, security program 914, device detection program 916, pre-loaded security data 918, temporary storage of captured image data 920, security breach records 922, and an operating system 924. For example, image capture routines 912 may include routines for controlling the image capture units 904 to capture image input data and store the same in temporary memory 90. Device detection program 916 may include subroutines for executing detection algorithms identifying and matching captured image data in the temporary memory 920 with recognition data from the pre-loaded security data 918, and the security program 914 may include routines for employing results from the device detection program 914 for identifying prohibited devices, identifying security measures associated with identified prohibited devices, executing identified security measures, and optionally creating security breach records 922. The operating system 924 provides routines for overall system functionality of the computing device 900.

The present invention contemplates implementation on a system or systems that provide multi-processor, multi-tasking, multi-process, and/or multi-thread computing, as well as implementation on systems that provide only single processor, single thread computing. Multi-processor computing involves performing computing using more than one processor. Multi-tasking computing involves performing computing using more than one operating system task. A task is an operating system concept that refers to the combination of a program being executed and bookkeeping information used by the operating system. Whenever a program is executed, the operating system creates a new task for it. Many operating systems, including Linux, UNIX®, OS/2®, and Windows®, are capable of running many tasks at the same time and are called multitasking operating systems. Multi-tasking is the ability of an operating system to execute more than one executable at the same time. Multi-process computing is similar to multi-tasking computing, as the terms task and process are often used interchangeably, although some operating systems make a distinction between the two.

The present invention may be a system, a method, and/or a computer program product at any possible technical detail level of integration. The computer program product may include a computer readable storage medium (or media) having computer readable program instructions thereon for causing a processor to carry out aspects of the present invention. The computer readable storage medium can be a tangible device that can retain and store instructions for use by an instruction execution device.

The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some examples, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to examples of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various examples of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present invention is described with reference to particular embodiments, it will be understood to those skilled in the art that the foregoing disclosure addresses exemplary embodiments only; that the scope of the invention is not limited to the disclosed embodiments; and that the scope of the invention may encompass any combination of the disclosed embodiments, in whole or in part, as well as additional embodiments embracing various changes and modifications relative to the examples disclosed herein without departing from the scope of the invention as defined in the appended claims and equivalents thereto.

The present invention is not limited to the exemplary embodiments illustrated herein, but is instead characterized by the appended claims, which in no way limit the scope of the disclosure.

What is claimed is:

1. An electronic device for securing sensitive data, the electronic device comprising one or more data capture units, a processor, memory accessible by the processor, and program instructions and data stored in the memory and executable by the processor, wherein:
the one or more data capture units are configured for capturing input data from a surrounding environment of the electronic device;
the processor is configured to control a security program stored in the memory to activate a persistent state of the electronic device in which the one or more data capture units continuously capture input data from the surrounding environment of the electronic device;
the processor is further configured to control a data recognition program stored in the memory to execute a comparative analysis of input data captured by the one or more data capture units to search for security tags within the captured input data;
the processor is further configured to, upon detecting a security tag within the captured input data, identify and execute one or more security measures associated with the detected security tag.

2. The electronic device according to claim 1, wherein
the electronic device is configured to temporarily store input data captured by the one or more data capture units in a temporary memory, and the processor is configured to control the security program to delete the captured input data from the temporary memory after executing the comparative analysis.

3. The electronic device according to claim 1, wherein
the electronic device is configured to constantly operate in the persistent state, to continuously capture input data from the surrounding environment of the electronic device, and repeatedly execute comparative analyses of input data captured by the one or more data capture units to search for security tags within the captured input data, and execute one or more security measures upon detecting a security tag, until such time that the processor controls the security program to deactivate the persistent state.

4. The electronic device according to claim 1, wherein
the one or more data capture units are configured to capture input data in the form of at least one of image data and audio data, and the processor is configured to control the security program to execute the comparative analysis in the form of at least one of an image matching analysis and an audio matching analysis.

5. The electronic device according to claim 4, wherein
the processor is configured to control the security program to execute the comparative analysis of the captured input data by comparing the captured input data to pre-loaded recognition data stored in the memory.

6. The electronic device according to claim 5, wherein
the pre-loaded recognition data comprises a security index comprising security tag identifiers for security tags that are predetermined to be in the environment of the electronic device and one or more security measures associated with each security tag identifier.

7. The electronic device according to claim 4, wherein
the processor is configured to control the security program to execute the comparative analysis of the captured input data to search for security tags in the form of at least one of an optical security tag and an auditory security tag.

8. The electronic device according to claim 1, wherein
the processor is configured to execute a security measure that comprises deactivating one or more capture units of the electronic device.

9. The electronic device according to claim 1, wherein
the processor is configured to execute a security measure that comprises controlling the electronic device to communicate with an external device for triggering the external device to execute a security action in the environment of the electronic device.

10. The electronic device according to claim 9, wherein
the processor is configured to execute a security measure that comprises triggering the external device to perform at one security action chosen from: depowering one or more external devices in the environment of the electronic device; closing and/or locking one or more entry and/or exit ways in the environment of the electronic device; and alerting security services in the environment of the electronic device.

11. A method of securing sensitive data with an electronic device, comprising:
capturing input data in a surrounding environment of the electronic device through one or more data capture units of the electronic device;
executing a comparative analysis of the captured input data by a data recognition program stored in a memory of the electronic device to search for security tags within the captured input data;
upon detecting a security tag within the captured input data, identifying and executing a security measure associated with the detected security tag.

12. The method of claim 11, further comprising
temporarily storing the captured input data in a temporary memory for use in the comparative analysis, and deleting the captured input data from the temporary memory after executing the comparative analysis.

13. The method of claim 11, wherein
a processor of the electronic device controls a security program stored in the memory of the electronic device to activate a persistent state of the electronic device in which the one or more data capture units continuously capture input data from the surrounding environment of the electronic device.

14. The method according to claim 13, wherein
while the electronic device is operating in the persistent state, the processor controls the security program to repeatedly execute comparative analyses of captured input data to search for security tags within the captured input data, and execute one or more security measures upon detecting a security tag, until such time that the processor controls the security program to deactivate the persistent state.

15. The method according to claim 11, wherein
the one or more data capture units capture input data in the form of at least one of image data and audio data, and comparative analysis is performed in the form of at least one of an image matching analysis and an audio matching analysis by comparing the captured input data to pre-loaded recognition data stored in the memory of the electronic device.

16. The method according to claim 15, wherein
the pre-loaded recognition data comprises a security index comprising security tag identifiers for security tags that are predetermined to be in the environment of the electronic device and one or more security measures associated with each security tag identifier.

17. The method according to claim 11, wherein
the comparative analysis comprises searching for security tags in the captured input data form of at least one of an optical security tag and an auditory security tag.

18. The method according to claim 11, wherein
the security measure comprises deactivating one or more capture units of the electronic device.

19. The method according to claim 11, wherein
the security measure comprises controlling the electronic device to communicate with an external device for triggering the external device to execute a security action in the environment of the electronic device.

20. The method according to claim 19, wherein
the security measure that comprises triggering the external device to perform at one security action chosen from: depowering one or more external devices in the environment of the electronic device; closing and/or locking one or more entry and/or exit ways in the environment of the electronic device; and alerting security services in the environment of the electronic device.
